(19) United States
(12) Patent Application Publication
(10) Pub. No.: US 2008/0084020 A1
(43) Pub. Date: Apr. 10, 2008

(54) Image forming apparatus and method of feeding media sheet for use in the same

(75) Inventor: Takeshi Nakamura, Kawasaki-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 11/905,770

(22) Filed: Oct. 4, 2007

(30) Foreign Application Priority Data
Oct. 4, 2006 (JP) JP 2006-273332
Sep. 10, 2007 (JP) JP 2007-234726

(51) Int. Cl. B41F 21/00

(52) U.S. Cl. 270/1.01; 271/259; 271/9.06

(57) ABSTRACT

An image forming apparatus includes a plurality of media trays, a specifying device, an acquisition device, and a determination device. The plurality of media trays are configured to load media sheets thereon. The specifying device specifies a condition on a media sheet for an image to be formed thereon and one of the plurality of media trays. The acquisition device acquires a condition on a media sheet to be loaded in the specified media tray. The determination device determines the presence or absence of the media sheet in accordance with the specified condition in the specified media tray by comparing the specified condition and the acquired condition. In the absence of the media sheet in the specified media tray, another media tray is searched for the media sheet. When the media sheet is found in the another media tray, the media sheet is fed from the another media tray.

### PRIORITY STATEMENT

The present patent application claims priority under 35 U.S.C. §119 upon Japanese Patent Applications No. JP2006-273332 filed on Oct. 4, 2006 and No. JP2007-234726 filed on Sep. 10, 2007 in the Japan Patent Office, the entire contents of which are hereby incorporated herein by reference.

### BACKGROUND

An image forming apparatus used as a printer, facsimile machine, copier, or multi-functional device thereof may have a plurality of media trays to load various sizes and types of media sheets, for example, plain paper sheets and high-quality paper sheets. When such an image forming apparatus is connected to host devices, for example, PCs (personal computers) via a network, operators may perform printing on various sizes and types of media sheets via the network.

On printing, an operator may specify one media tray containing a media sheet in accordance with image data from a plurality of media trays. There are several known methods of specifying one media tray from a plurality of media trays. For example, in a conventional image forming apparatus, an operator may use an automatic specifying mode in which one appropriate tray is automatically selected based on the size of image data, or a manual specifying mode in which an operator specifies a given media size, media type, and/or media tray.

In the automatic specifying mode, the conventional image forming apparatus receives image data from a host device, selects a media size and type in accordance with the image data, and specifies one media tray containing a sheet of the appropriate size and type from a plurality of media trays.

On the other hand, in the manual specifying mode, the operator selects and specifies a media size, media type, and/or media tray from an input device, for example, an operation panel on the conventional image forming apparatus, or a host device.

However, in the automatic specifying mode and/or manual specifying mode, when the specified media sheet is not loaded in the specified tray or when the specified tray runs out of the sheets during printing, the conventional image forming apparatus may display a message indicating such sheet empty state on the operation panel and may temporarily stop the printing operation. Further, in response to the message, the operator may be forced to manually specify another media tray or load an appropriate media sheet in the specified media tray.

Alternatively, a media sheet in accordance with an image size and media type obtained from print data may not be found in any of the media trays. In such a case, the operator may need to select one media tray from the plurality of media trays and load the media sheet in accordance with the print data in replacement of the media sheet being loaded in the selected tray. If such a replacement operation is repeatedly required when an appropriate media tray is not found, other operators using the conventional image forming apparatus may be encountered to a lower efficiency of print operations.

Hence, a conventional image forming apparatus carries out processing in an automatic specifying mode as follows.

The conventional image forming apparatus recognizes information on media sheets to be loaded in a plurality of media trays, for example, media sizes and types, compares such information on the media sheets with information on print data transmitted from a data processing device (e.g., PC), for example, image size and media type, and determines whether or not an appropriate media sheet is loaded in the media trays.

When the appropriate media sheet is not found in any of the media trays, the conventional image forming apparatus selects a predetermined “escape” media tray and performs an image forming operation on a media sheet fed from the predetermined “escape” media tray.

FIG. 1 is an illustration of an image recording process of a conventional image recording apparatus. In FIG. 1, information on a media sheet obtained from print data transmitted from a data processing device, for example, a PC indicates that “A4” and “plate sheet” are specified as media size and media type, respectively.

On the other hand, information on media sheets to be loaded in respective media trays of the conventional image recording apparatus indicates that: for a media tray X, the media size and media type to be loaded therein are set to “A4” and “plain sheet”, respectively, but such a media sheet is currently not loaded; for a media tray Y, the media size and media type to be loaded therein are set to “A4” and “plain sheet”, respectively, and such a media sheet is currently loaded; for a media tray Z, the media size and media type to be loaded therein are set to “A3” and “plain sheet”, respectively, and such a media sheet is currently loaded; and, for an “escape” media tray, the media size and media type to be loaded therein are set to “A4” and “plain sheet”, respectively, and such a media sheet is currently loaded. Here, an operator is assumed to specify the media tray X.

The image recording apparatus searches the plurality of media trays for the media sheet in accordance with the print data in a predetermined priority order. For example, the priority may be set in a descending order of the media tray X, the media tray Y, and the media tray Z. The image recording apparatus compares the information on the media sheet in accordance with the print data with the information on the media sheet to be loaded in the media tray X. If the two pieces of information match but the appropriate media sheet is not currently loaded in the tray X, the image recording apparatus determines that the sheet feeding operation from the media tray X is not executable, and searches another media tray for the appropriate media sheet.

Similarly, the image recording apparatus compares the information on the media sheet in accordance with the print data with the information set as the media sheet to be loaded in the media tray Y. If the two pieces of information match and the appropriate media sheet is currently loaded in the tray Y, the image recording apparatus feeds the media sheet from the tray Y.

Alternatively, if the appropriate media sheet is not found in any of the media trays X, Y, and Z, the image recording apparatus feeds a media sheet from the “escape” media tray.

Thus, in the automatic specifying mode, when a sheet of a size and type specified by an operator is loaded in two or more trays of the plurality of media trays, the image recording apparatus may automatically feed the sheet of the specified size and type from another tray even if the specified tray runs out of the sheet. Thus, the image recording apparatus may continue printing operations while avoiding interruption of printing caused by the loading operation of sheet.

Further, by setting the “escape” media tray, the image recording apparatus may perform printing even if the sheet of the specified size and type is not loaded in any of the media trays X, Y, and Z.

However, for the image recording apparatus, the above-described image recording processing is applicable only to the automatic specifying mode, and not to the manual specifying mode. Consequently, in the manual specifying mode, when the specified tray runs out of the sheet of the specified size and type, the printing operation is temporarily stopped even if the sheet is loaded in a media tray other than the specified tray.

### SUMMARY

The present specification provides an image forming apparatus capable of feeding an appropriate media sheet in an manual specifying mode without stopping a printing operation when a sheet of a size and type specified by an operator is not loaded in a specified media tray or when the specified tray runs out of the sheet of the specified size and type.

In at least one example embodiment of the present specification, an image forming apparatus includes a plurality of media trays, a specifying device, an acquisition device, and a determination device. The plurality of media trays are configured to load media sheets thereon. The specifying device is configured to specify a condition on a media sheet for an image to be formed thereon and one media tray of the plurality of media trays. The acquisition device is configured to acquire a condition on a media sheet to be loaded in the media tray specified using the specifying device. The determination device is configured to determine the presence or absence of the media sheet in accordance with the specified condition in the specified media tray by comparing the specified condition and the acquired condition. When the determination device determines the absence of the media sheet in accordance with the specified condition in the specified media tray, another media tray of the plurality of media trays is searched for the media sheet in accordance with the specified condition. When the media sheet in accordance with the specified condition is found in the another media tray, the media sheet is fed from the another media tray.

Additional features and advantages will be more fully apparent from the following detailed description, the accompanying drawings, and the associated claims.

### BRIEF DESCRIPTION OF THE DRAWINGS

A more complete appreciation of the subject matter of this disclosure and many of the attendant advantages thereof will be readily obtained as the same becomes better understood by reference to the following detailed description when considered in connection with the accompanying drawings, wherein:

FIG. 1 is an illustration of an image recording process executed in a conventional image forming apparatus;

FIG. 2 is a schematic view illustrating a configuration of a network including image forming apparatuses according to an example embodiment;

FIG. 3 is a block diagram of an image forming apparatus according to an example embodiment;

FIG. 4 is a schematic view of an image forming apparatus according to an example embodiment;

FIG. 5 is a flow chart illustrating a process from a setting operation prior to print processing to a sheet feeding operation;

FIG. 6 illustrates a display screen of an operation panel for setting information on each media tray;

FIG. 7 illustrates a display screen of an operation panel for setting tray switching function and advanced automatic-tray-switching function;

FIG. 8 illustrates a display screen in a host device for an operator to manually specify a desired media size, media type, and media tray;

FIG. 9 is a flow chart illustrating (according to an example embodiment) a procedure of print control executed when an image forming apparatus feeds a media sheet from a media tray selected by a normal automatic tray selection;

FIG. 10 is a flow chart illustrating (according to an example embodiment) a procedure of print control executed when an image forming apparatus feeds a media sheet by automatic-tray-switching feeding.

FIG. 11 is a flow chart illustrating (according to an example embodiment) a procedure of print control when an image forming apparatus feeds a media sheet by advanced automatic-tray-switching feeding;

FIG. 12 is an illustration of an example of print control executed in an image forming apparatus when a media size specified by an operator does not match a media size set for a media tray specified by the operator; and

FIG. 13 is an illustration of an example of print control executed in an image forming apparatus when a media sheet of a size and type specified by an operator is not loaded in a media tray specified by the operator.

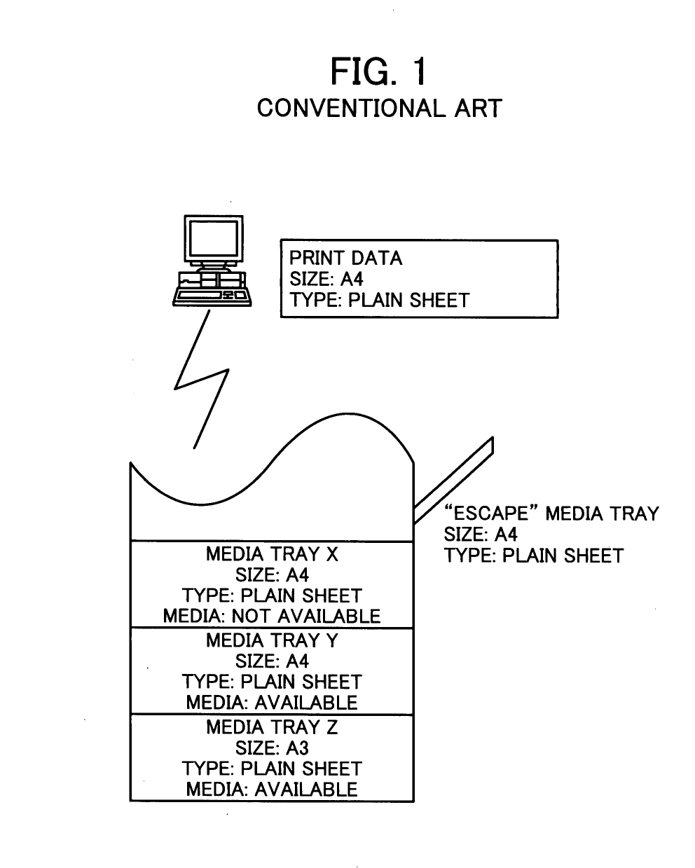

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like may be used herein to facilitate description of one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a term such as “below” can encompass both an orientation of above and below. The device may be otherwise oriented (rotated 90 degrees or at other orientations) and the spatially relative descriptors herein interpreted accordingly.

Although the terms first, second, etc., may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present disclosure.

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. For the sake of simplicity, the same reference numerals are used in the drawings and the descriptions for the same materials and constituent parts having the same functions, and descriptions thereof are omitted unless otherwise stated.

Example embodiments of the present disclosure are now described below with reference to the accompanying drawings. It should be noted that, in a later-described comparative example, example embodiment, and alternative example, the same reference numerals are used for the same constituent elements, for example, parts and materials having the same functions, and descriptions thereof omitted.

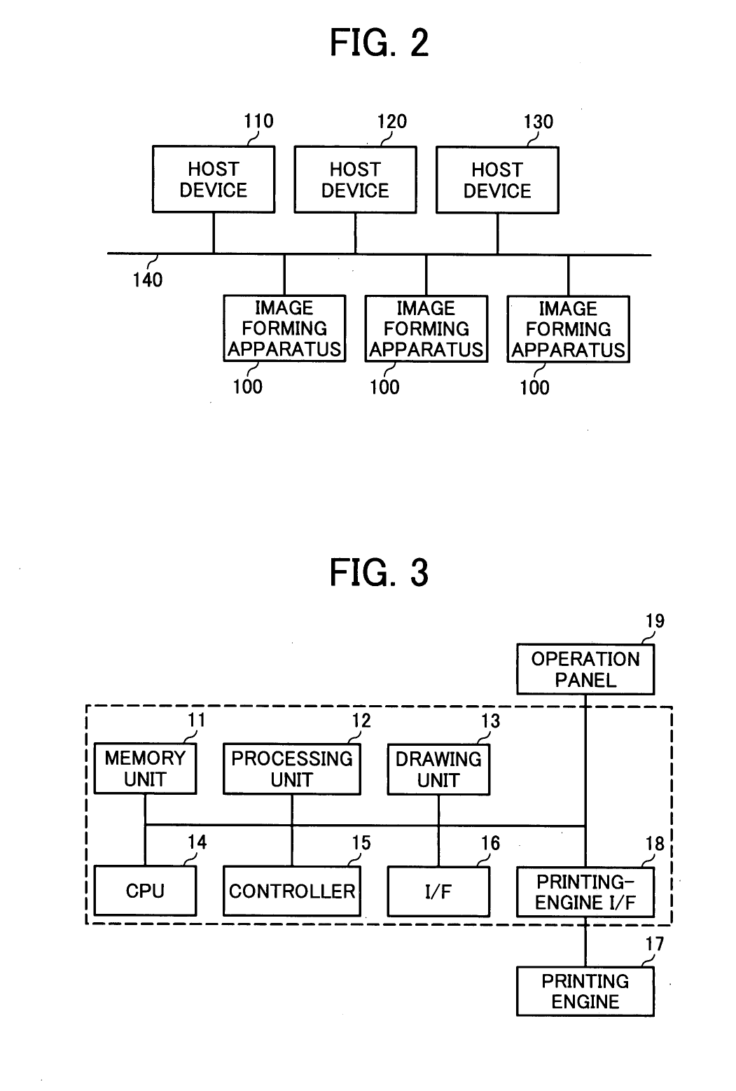

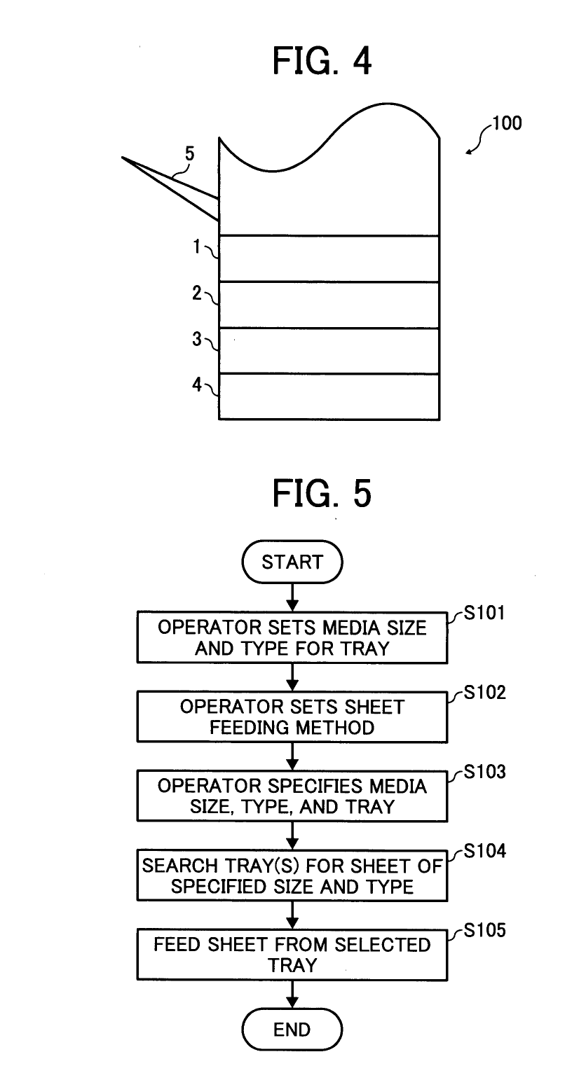

First, an image forming apparatus according to an example embodiment is described with reference to FIGS. 2 and 4.

FIG. 2 is a schematic view illustrating a configuration of a network including image forming apparatuses according to an example embodiment.

Image forming apparatuses 100 are connected to host devices 110, 120, and 130, for example, PCs, via a network 140. Print data created at the host devices 110, 120, and 130 are transmitted to the image forming apparatuses 100 via the network 140.

Next, a schematic configuration of the image forming apparatus is described with reference to FIG. 3. FIG. 3 is a block diagram of an image forming apparatus 100 according to an example embodiment. As illustrated in FIG. 3, the image forming apparatus 100 may include a memory unit 11, a processing unit 12, a drawing unit 13, a CPU (central processing unit) 14, a controller 15, an I/F (interface) 16, a printing engine 17, a printing engine I/F 18, and an operation panel 19.

The memory unit 11 may include a ROM (read-only memory), a RAM (random access memory), an image memory, and/or any other suitable memory. The memory unit 11 may store image data temporarily and programs for controlling the image forming apparatus 100.

The processing unit 12 receives image data from a host device, for example, a PC (personal computer), analyzes the image data for each of PDL (page description language) control codes, and converts the image data into drawing commands.

Based on the drawing commands, the drawing unit 13 draws and stores an image as the image data in the image memory of the memory unit 11.

The CPU 14 generally controls the image forming apparatus 100 by executing the program stored in the ROM of the memory unit 11. The controller 15 controls respective components of the image forming apparatus in cooperation with the CPU 14.

The I/F 16 connects the image forming apparatus 100 to one or more host devices via a network, for example. The image forming apparatus 100 receives image or other data from such host devices through the I/F 16.

The printing engine 17 is a printing system that receives instructions through the printing engine I/F 18 and drives according to the received instructions.

The operation panel 19 is provided on the image forming apparatus 100. An operator may perform various input and checking operations from the operation panel 19. For example, in a manual specifying mode described later in detail, the operator may specify a desired media tray from the operation panel 19.

FIG. 4 is a schematic view of an image forming apparatus according to an example embodiment. As illustrated in FIG. 4, an image forming apparatus 100 may include a four-tiered media-tray unit formed by media trays 1 to 4. To an upper portion of the image forming apparatus 100 may be provided an output tray 5 to which a sheet is ejected.

The image forming apparatus 100 has a tray switching function. With the function set to ON, when a media size, media type, and media tray are specified by an operator in the manual specifying mode and a sheet of the specified size and type is not loaded in the specified tray, the image forming apparatus 100 automatically searches another media tray for the sheet of the specified size and type and selects a media tray containing the sheet, if any.

Hereinafter, such a sheet feeding operation performed with the tray switching function set to ON is referred to as automatic-tray-switching feeding or a first feeding method.

The image forming apparatus 100 also has an “advanced automatic-tray-switching” function. An operator may give higher priority to immediate execution of printing rather than precise match on media size and type.

Hence, when the advanced automatic-tray-switching function is set to ON, and a media size, type, and tray are specified by an operator in the manual specifying mode, the image forming apparatus 100 selects the specified tray as long as the specified media size matches information on the media type loaded in the specified tray. In this case, the image forming apparatus 100 selects the specified tray even if the specified media type does not match the information set as the media type to be loaded in the specified tray.

Hereinafter, such a sheet feeding operation performed with the advanced automatic-tray-switching function set to ON is referred to as advanced automatic-tray-switching feeding or a second feeding method.

FIG. 5 is a flow chart illustrating a process from a setting operation prior to print processing to a sheet feeding operation executed in the manual specifying mode.

At S101, an operator sets information on a media size and type to be loaded in each media tray from an operation panel 19.

At S102, the operator sets the method of selecting a media tray from the operation panel 19. At this time, the operator sets the tray switching function and the advanced automatic-tray-switching function to ON or OFF.

At S103, the operator specifies a desired media size, media type, and media tray.

At S104, the image forming apparatus 100 searches the specified media tray for a sheet of the specified size and type. Further, if the tray switching function or the advanced automatic-tray-switching function is set to ON at S102 and the sheet of the specified size and type is not loaded in the specified tray, the image forming apparatus 100 searches another tray for the sheet of the specified size and type.

At S105, the image forming apparatus 100 selects a media tray containing the sheet of the specified size and type and feeds the sheet from the media tray.

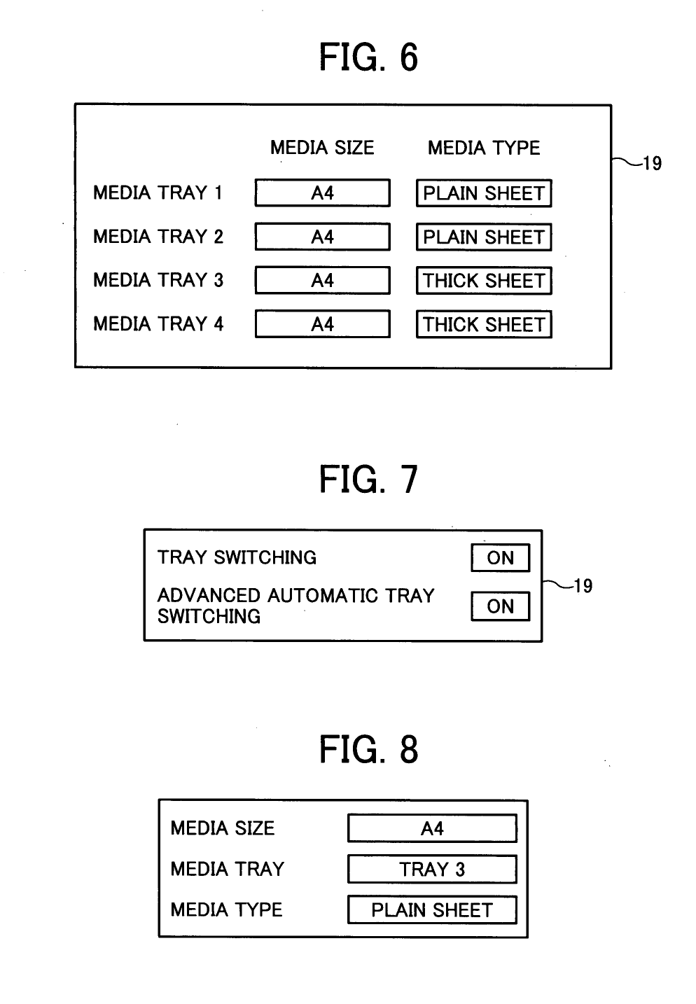

Next, the process in the manual specifying mode is described in detail with reference to FIGS. 6 to 8.

FIG. 6 illustrates a display screen of the operation panel 19 on the image forming apparatus 100. The display screen is used for an operator to set information on media size and type to be loaded in each media tray. The display screen indicates that “plain sheet” and “A4” are set as the media size and type to be loaded in each of the media trays 1 and 2, while “thick sheet” and “A4” are set as the media size and type to be loaded in each of the media trays 3 and 4. In this setting, when an operator touches the button indicating the media size of the media tray 1, a dropdown list appears so that other media sizes, for example, B4 and A3 become selectable. Similarly, a plurality of media types are selectable in the form of a dropdown list.

By this specifying operation, the information on sheets to be loaded in the media trays is input to the image forming apparatus 100. The specifying operation may be performed either before or after the loading of media sheets into the media trays as long as it is performed before the start of print processing.

FIG. 7 illustrates a display screen of the operation panel 19 for an operator to make settings on the tray switching function and/or the advanced automatic-tray-switching function at S102 of FIG. 5. With the display screen, the operation panel 19 serves as a switching device of media trays. The operator may switch between the methods of selecting a media tray by turning the tray switching function and the advanced automatic-tray-switching function ON or OFF. The display screen of FIG. 7 indicates that both the tray switching function and the advanced automatic-tray-switching function are set to ON, that is, an active state.

Table 1 illustrates a list of the methods of selecting a media tray to be performed when the tray switching function and the advanced automatic-tray-switching function are set to ON or OFF in the automatic specifying mode.

TABLE 1

| | | ADVANCED AUTOMATIC | |
|---|---|---|---|
| | | TRAY SWITCHING | |
| | | OFF | ON |
| TRAY | OFF | NORMAL | ADVANCED |
| SWITCHING | | AUTOMATIC | AUTOMATIC |
| | | TRAY SELECTION | TRAY SWITCHING |
| | ON | TRAY SWITCHING | ADVANCED |
| | | | AUTOMATIC |
| | | | TRAY SWITCHING |

As illustrated in Table 1, when the advanced automatic-tray-switching function is set to ON, a higher priority is given to the advanced automatic-tray-switching function regardless of the ON or OFF state of the tray switching function. Thus, the image forming apparatus 100 performs the advanced automatic feeding is performed.

Accordingly, in the case of the display screen illustrated in FIG. 7, a higher priority is given to the advanced automatic-tray-switching function over the tray switching function. Thus, the image forming apparatus 100 performs the advanced automatic feeding.

Alternatively, when the advanced automatic-tray-switching function is set to OFF and the tray switching function is ON, the image forming apparatus 100 employs the tray switching function to perform the automatic-tray-switching feeding.

When both the advanced automatic-tray-switching function and the tray switching function are set to OFF, a predetermined media tray is selected (herein, referred to as a normal automatic tray selection) and a normal automatic feeding or a third feeding method is performed to feed a media sheet from the predetermined media tray.

Alternatively, on setting both the advanced automatic-tray-switching function and the tray switching function to OFF at S102 of FIG. 5, the operator may also make settings from the operation panel 19 on how to select one preferential feeding method from the above-described feeding methods including the advanced automatic feeding, the automatic-tray-switching feeding, and the normal automatic feeding. In such a case, the operator may select a default feeding method or a feeding method used in the preceding print processing as the preferential feeding method.

If the advanced automatic-tray-switching function is set to ON, the specification of the media type performed by the operator is disabled. As a result, the sheet feeding operation is performed as long as the media size specified by the operator matches the information set as the media size to be loaded in the specified media tray. Thus, a higher priority is given to the execution of printing over the matching of media type.

Even in the automatic specifying mode, the operator may make settings on the tray switching function and/or the advanced automatic-tray-switching function in the image forming apparatus 100. In this case, however, as illustrated in Table 2, the image forming apparatus 100 selects one media tray from the plurality of media trays by performing the normal automatic tray selection regardless of the ON or OFF state of the tray switching function and the advanced automatic-tray-switching function.

TABLE 2

| | | ADVANCED AUTOMATIC | |
|---|---|---|---|
| | | TRAY SWITCHING | |
| | | OFF | ON |
| TRAY | OFF | NORMAL AUTOMATIC | NORMAL |
| SWITCH- | | TRAY SELECTION | AUTOMATIC |
| ING | | | TRAY SELECTION |
| | ON | NORMAL AUTOMATIC | NORMAL |
| | | TRAY SELECTION | AUTOMATIC |
| | | | TRAY SELECTION |

FIG. 8 illustrates a display screen on a host device for an operator to specify a desired media size, media tray, and media type at S103 of FIG. 5 in the manual specifying mode.

The display screen indicates that the operator specifies “A4” as media size, “tray 3” as media tray, and “plain sheet” as media type. The specified data is transmitted together with the print data to the image forming apparatus 100 and is stored in the memory unit 11 illustrated in FIG. 3. The specifying operation may be performed at the image forming apparatus 100. In such a case, the operator specifies the media size, type, and tray from the operation panel 19 serving as a specifying device. However, if the advanced automatic-tray-switching function is set to ON at S102 of FIG. 5, the specification of the media type performed from the operation panel 19 is disabled.

Next, descriptions are given of procedures of printing processes executed when the image forming apparatus 100 performs sheet feeding operations according to the respective tray-selection methods, for example, the normal automatic feeding, the automatic-tray-switching feeding, and the advanced automatic-tray-switching feeding. Each printing process described below is controlled by the CPU 14 to execute programs stored in the memory unit 11. As described below, the CPU 14 serves as an acquisition device and additionally a determination device in the image forming apparatus 100.

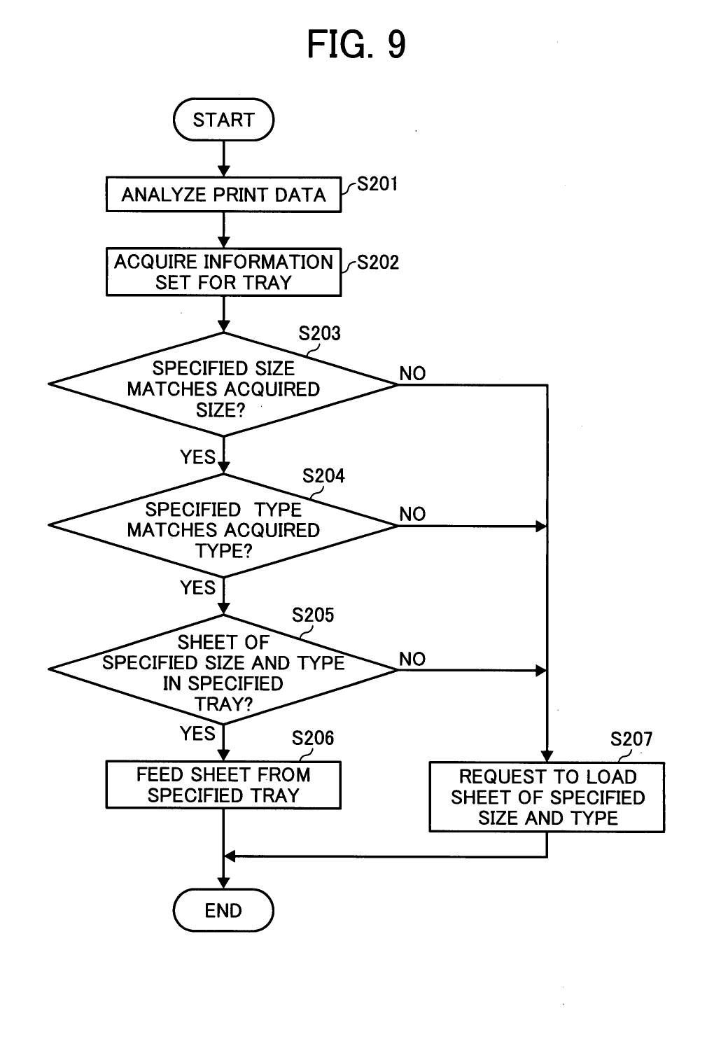

FIG. 9 is a flow chart illustrating a procedure of print control executed when the image forming apparatus 100 performs the normal automatic feeding. In other words, the flow chart of FIG. 9 illustrates a procedure of print control of the image forming apparatus 100 executed when both the advanced automatic-switching-tray function and the tray switching function are set to OFF in the manual specifying mode (see Table 1).

At S201, the CPU 14 analyzes print data received from a host device and obtains information on a media size and type specified by an operator through the analysis of the print data.

At S202, the CPU 14 acquires the information previously set for a media tray stored in the memory unit 11, that is, the information previously set as the media size and type to be loaded in a media tray.

At S203, the CPU 14 compares the specified media size included in the print data with the media size set for the media tray included in the acquired information.

At S204, the CPU 14 compares the specified media type included in the print data with the media type set for the media tray included in the acquired information.

If the specified media size and type match the acquired media size and type, respectively (“YES” at both S203 and S204), at S205, the CPU 14 determines whether or not the sheet of the specified size and type is loaded in the media tray.

If the sheet is loaded in the specified tray (“YES” at S205), at S206, the sheet is fed from the media tray.

If the specified size does not match the acquired size (“NO” at S203) or the specified type does not match the acquired type (“NO” at S204), at S207, the CPU 14 instructs the operation panel 19, serving as a notification device, to display a message requesting the loading of sheet in the media tray.

Alternatively, if the specified media size and type match the acquired media size and type, respectively (“YES” at both S203 and S204), but the sheet of the specified size and type is not loaded in the media tray (“NO” at S205), at S207, the CPU 14 instructs the operation panel 19 to display a message requesting the loading of sheet into the media tray.

Although not illustrated in FIG. 9, when the operator loads the sheet into the media tray in response to the message, the processing from S203 to S206 is repeated and, at S206, the sheet is fed from the tray.

As described above, in the case where a media sheet is fed from a media tray automatically selected by the automatic tray selection, if the information on a media sheet specified by an operator matches the information on a media sheet to be loaded in a media tray specified by the operator, the image forming apparatus 100 performs the printing operation. On the other hand, if the two pieces of information do not match, the image forming apparatus 100 stops the printing operation and only requests the operator to load the specified media sheet.

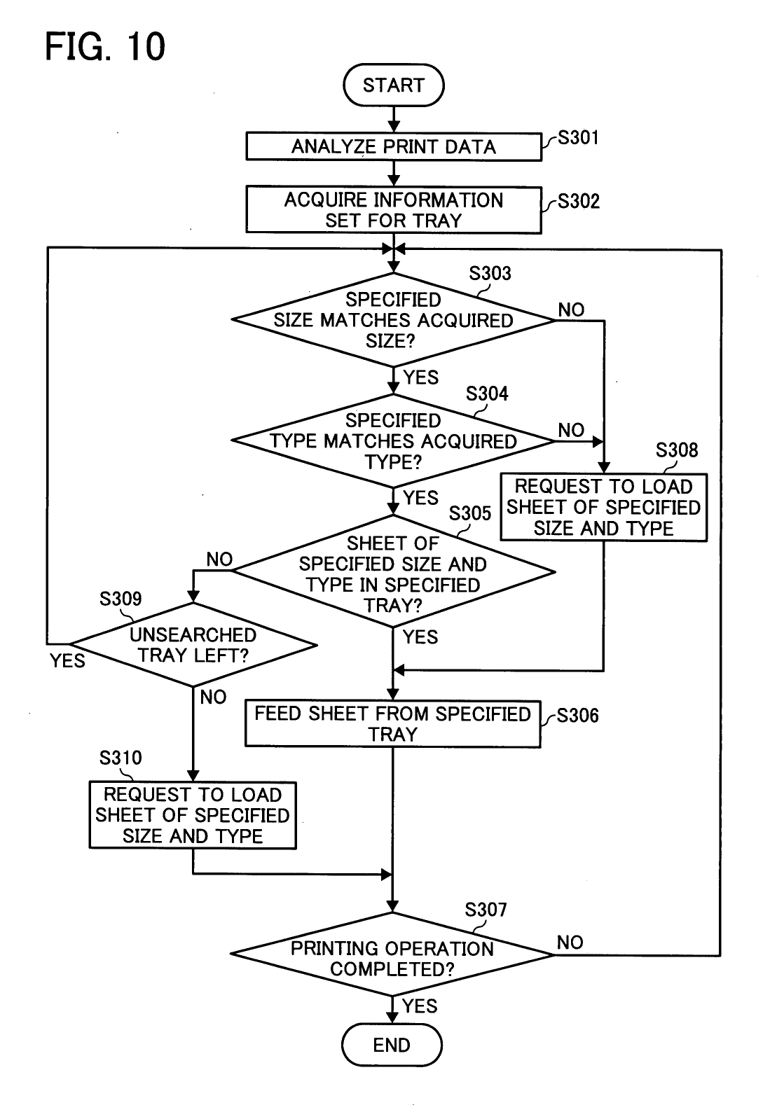

FIG. 10 is a flow chart illustrating a procedure of print control executed when the image forming apparatus 100 performs the automatic-tray-switching feeding. In other words, the flow chart of FIG. 10 illustrates a procedure of print control of the image forming apparatus 100 executed when the advanced automatic-tray-switching function is set to OFF and the tray switching function is set to ON in the manual specifying mode (see Table 1).

At S301, the CPU 14 analyzes print data received from a host device and obtains information on a media size, type, and tray specified by an operator through the analysis of the print data.

At S302, the CPU 14 acquires the information on each media tray, that is, the information previously set as the media size and type to be loaded in a media tray (S302).

At S303, the CPU 14 compares the specified media size included in the print data with the acquired media size.

At S304, the CPU 14 compares the specified media type included in the print data with the acquired media type.

If the specified media type does not match the acquired media type (“NO” at S303) or the specified media size does not match the acquired media size (“NO” at S304), at S308, the CPU 14 instructs the operational panel 19 to display a message requesting the loading of the sheet of the specified size and type into the specified tray.

When the sheet is loaded into the specified tray in response to the message, at S306, the sheet is fed from the specified tray.

Alternatively, if the specified size and type match the acquired size and type, respectively (“YES” at both S303 and S304), at S305, the CPU 14 determines whether or not the sheet is loaded in the specified tray based on results detected by a sensor, for example.

If the sheet is loaded in the specified tray (“YES” at S305), at S306, the sheet is fed from the specified tray.

At S307, the CPU 14 determines whether or not the printing operation is completed, that is, the number of media sheets requested by the print data is already printed.

If the printing operation is not completed (“NO” at S307), the processing goes back to S303.

On the other hand, if the printing operation is completed (“YES” at S307), the processing ends.

Alternatively, if the sheet of the specified size and type is not loaded in the specified tray (“NO” at S305), at S309, the CPU 14 searches whether or not an unsearched tray is left.

If an unsearched tray is found (“YES” at S309), the processing goes back to and is repeated from S303 for the unsearched tray.

On the other hand, if an unsearched tray is not found (“NO” at S309), at S310, the CPU 14 instructs the operation panel 19 to display a message requesting the loading of the sheet of the specified size and type.

If the printing operation is not completed (“NO” at S307), the processing is repeated from S303.

As described above, for the automatic-tray-switching feeding, if a sheet of a media size and type specified by an operator is not loaded in a media tray specified by the operator in the automatic specifying mode, the image forming apparatus 100 determines whether or not an unsearched tray is left. If an unsearched tray is left, the image forming apparatus 100 determines whether or not the specified media size and type matches the size and type set for the unsearched tray, and whether or not the sheet of the specified size and type is currently loaded in the unsearched tray. Thus, the image forming apparatus 100 is capable of automatically feeding a sheet of the specified size and type from a media tray other than the specified tray.

Accordingly, even if the sheet of the specified type and size is not loaded in the specified tray, when the sheet is loaded in another tray, the image forming apparatus 100 may perform printing without stopping for the loading of the sheet. Thus, the image forming apparatus 100 may provide an increased print efficiency.

Here, if the sheet of the specified type and size is not loaded in the specified tray (“NO” at S305 of FIG. 10) and a plurality of unsearched trays are left, the plurality of unsearched trays are searched in a predetermined priority order.

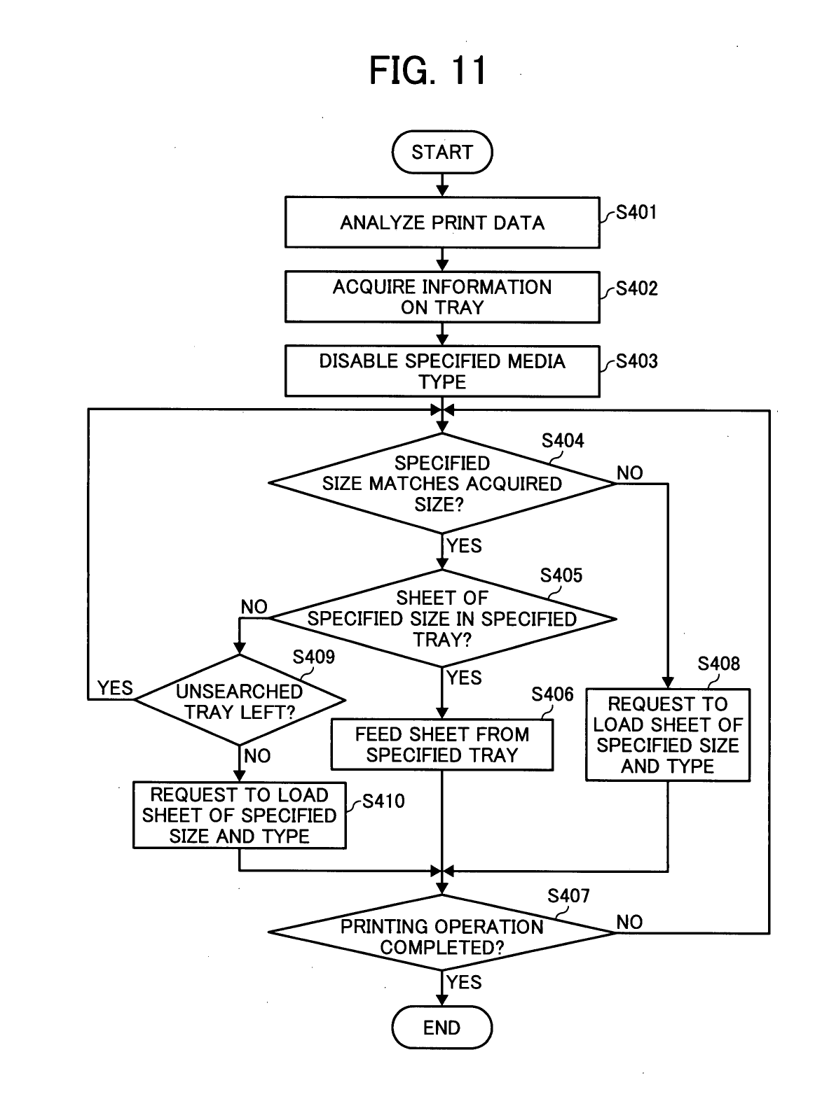

FIG. 11 is a flow chart illustrating a procedure of print control executed when the image forming apparatus 100 performs the advanced automatic feeding. In other words, FIG. 11 illustrates a procedure of print control executed in the image forming apparatus 100 when the advanced automatic-tray-switching function is set to ON in the manual specifying mode (see Table 1). The flow chart of FIG. 11 partially includes processing identical to that of the flow chart of FIG. 10, and therefore only different processing between the two charts are mainly described below.

Processing at S401, S402, S404, and S405 to S410 in FIG. 11 are identical to processing S301, S302, S303, and S305 to S310 in FIG. 10, respectively.

At S402, the CPU 14 acquires information on each media tray, that is, information set as the media size and type to be loaded in a media tray specified by an operator.

At S403, information on the media type specified by the operator, received from a host device, is overwritten with the acquired information on the media type set for the specified tray. Thus, the specification of media type performed by the operator is disabled.

At S404, the CPU 14 determines whether or not the specified media size included in print data matches the media size set for the specified tray included in the acquired information.

If the specified media size does not match the acquired media size (“NO” at S404), at S408, the CPU 14 instructs the operation panel 19 to display a message requesting the loading of the sheet of the specified type and size in the specified tray.

Alternatively, if the specified media size matches the acquired media size (“YES” at S404), at S405, the CPU 14 determines whether or not the sheet of the specified size is actually loaded in the specified tray.

If the sheet of the specified size is actually loaded in the specified tray (“YES” at S405), at S406, the sheet of the specified size is fed from the specified tray and printing is performed on the sheet.

For the manual specifying mode as described above, the operator may select, from the operation panel 19, one desired feeding method from the plurality of feeding methods including the normal automatic feeding, the automatic-tray-switching feeding, and the advanced automatic feeding. Thus, the image forming apparatus 100 is provided with an enhanced versatility and is capable of performing printing according to a feeding method suitable for meeting various needs of operators.

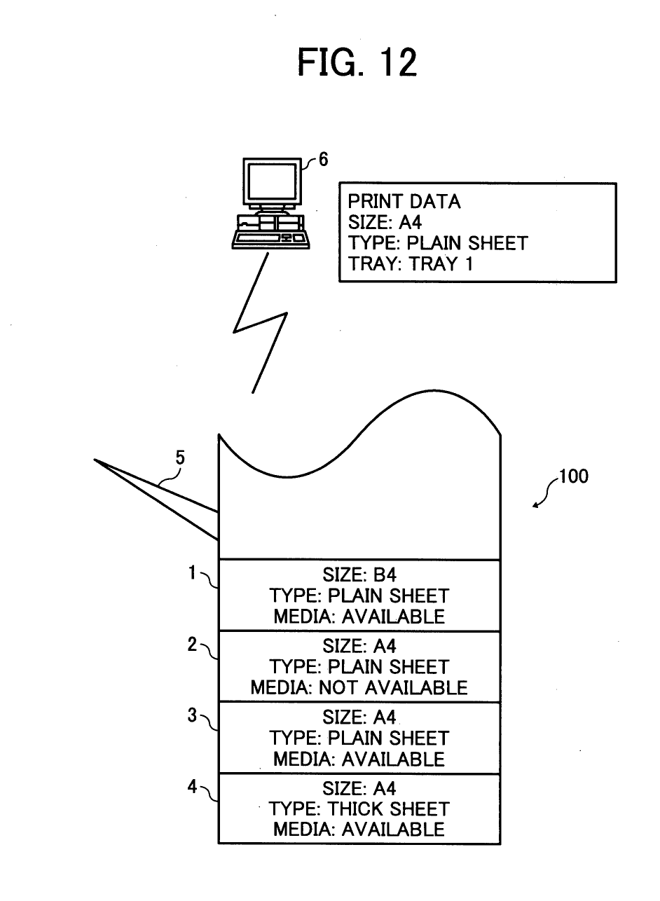

Next, with reference to FIG. 12, a description is given of an example of print control of the image forming apparatus 100 performed when the acquired information on the media size set for the specified tray does not match the information on the specified media size with the tray switching function or the advanced automatic-tray-switching function being set to ON.

A host device 6 transmits print data, including a media size, type, and tray specified by an operator, to the image forming apparatus 100. The image forming apparatus 100 analyzes the received print data at S301 of FIG. 10 or S401 of FIG. 11 and obtains information of the media size “A4”, the media type “plain sheet”, and the media tray “tray 1”, for example.

The CPU 14 acquires the information on the media trays 1 to 4. For example, as illustrated in FIG. 12, for tray 1, the media size and type to be loaded therein are set to “B4” and “plain sheet”, respectively, at S101 of FIG. 5.

In the print control, at S303 of FIG. 10 or S404 of FIG. 11, the CPU 14 determines whether or not the media size specified by the operator matches the media size set for the specified tray 1, for example. In an example illustrated in FIG. 11, the specified media size is “A4”, while the media size to be loaded in the specified tray 1 is “B4”. That is, the specified size does not match the media size to be loaded in the specified tray, and thus at S308 of FIG. 10 or S408 of FIG. 11 the message requesting the operator to load a sheet of the specified “A4” size is displayed on the operation panel 19. In response to the message, the operator loads a sheet of A4 size in the tray 1 and sets “A4” as the media size for the tray 1.

At this time, the printing operation is not completed, and thus the processing goes back to and is repeated from S303 of FIG. 10 or S404 of FIG. 11. At S303 or S404, the CPU 14 determines again whether or not the specified media size matches the information set as the media size to be loaded in the tray 1. If both the sizes match, the CPU 14 determines whether or not a sheet of the specified size is actually loaded in the tray 1. If loaded in the tray 1, the sheet is fed therefrom.

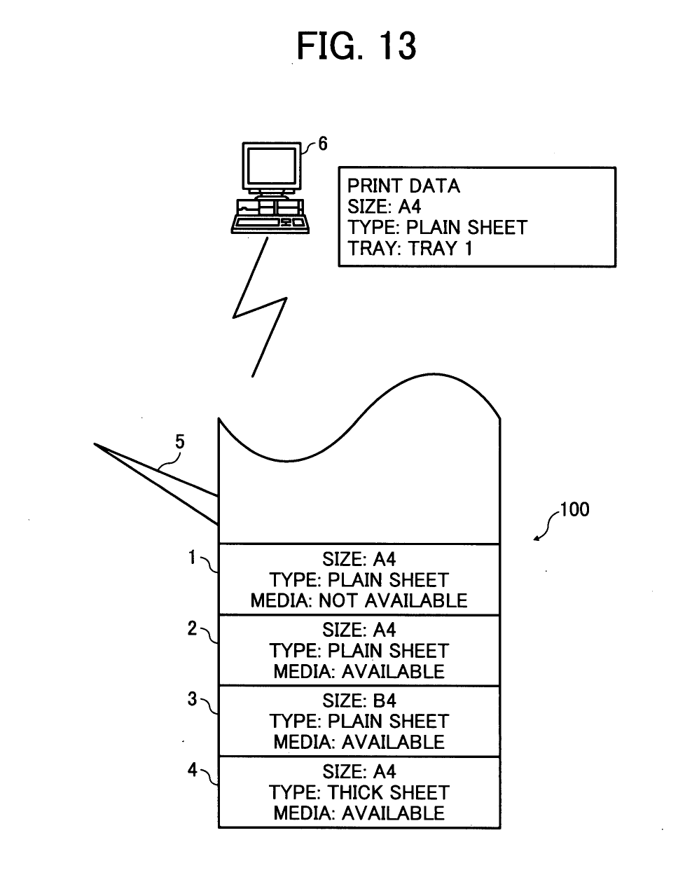

Next, with reference to FIG. 13, a description is given of an example of print control executed in the image forming apparatus when an media sheet of a size and type specified by an operator is not actually loaded in a media tray specified by the operator with the tray switching function or the advanced automatic-tray-switching function being set to ON.

As illustrated in FIG. 13, a host device 6 transmits, to the image forming apparatus 100, print data including information on a media size, type, and tray specified by the operator.

The image forming apparatus 100 analyzes the received print data at S301 of FIG. 10 or S401 of FIG. 11, and obtains information of the media size “A4”, the media type “plain sheet”, and the media tray “tray 1”, for example. The CPU 14 acquires information on the media trays 1 to 4. For example, as illustrated in FIG. 13, the media size and type to be loaded in the tray 1 may be set to “A4” and “plain sheet” at S101 of FIG. 5.

In the print control, at S303 of FIG. 10 or S404 of FIG. 11, the CPU 14 determines whether or not the specified media size matches the media size set for the specified tray 1. In an example illustrated in FIG. 13, the specified media size is “A4”, while the media size to be loaded in the specified tray 1 is “A4”. Therefore, the CPU 14 determines that the specified media size matches the media size to be loaded in the tray 1.

At S305 of FIG. 10 or S405 of FIG. 11, the CPU 14 determines whether or not the sheet of the specified size and type is actually loaded in the specified tray 1. In the example illustrated in FIG. 13, the sheet of the specified size and type is not loaded in the specified tray 1 and thus the processing goes to S309 of FIG. 10 or S409 of FIG. 11.

Because the image forming apparatus 100 has the other media trays 2 to 4, at S309 of FIG. 10 or S409 of FIG. 11, the CPU 14 determines that an unsearched media tray is left. At S303 of FIG. 10 or S404 of FIG. 11, for a media tray having the second-highest priority, the CPU 14 determines whether or not the specified media size matches the media size set for the media tray. Here, the media tray having the second-highest priority is assumed to be the tray 2. However, it is not limited to the tray 2 and may be the tray 3 or 4.

In FIG. 13, the specified media size is “A4”, and the media size set for the tray 2 having the second-highest priority is “A4”. Therefore, the CPU 14 determines that the specified media size matches the media size set for the tray 2.

At S305 of FIG. 10 or S405 of FIG. 11, the CPU 14 determines whether or not the sheet of the specified size and type is currently loaded in the tray 2. In the state illustrated in FIG. 13, the sheet of the specified size and type is available in the tray 2 and thus, at S306 of FIG. 10 or S406 of FIG. 11, the sheet is fed from the tray 2.

At S307 of FIG. 10 or S407 of FIG. 11, the CPU 14 determines whether or not the printing operation is completed, that is, whether or not the number of sheets required by the print data is already printed. If the printing operation is completed, the print processing ends. Alternatively, if the printing operation is not completed, the above-described print processing is repeated until the printing operation is completed.

Further, if the specified tray runs out of the sheet of the specified size and type during the printing operation, the print control is executed from S305 of FIG. 10 or S405 of FIG. 11, and the image forming apparatus 100 attempts to feed a sheet of the specified size and type from another media tray.

According to the above-described method of feeding a media sheet, even when a media sheet of a size and type specified by an operator is not available in a media tray specified by the operator, or even when a media tray specified by an operator runs out of a media sheet of a size and type specified by the operator, an image forming apparatus is capable of feeding a media sheet from a media tray other than the specified tray without stopping the printing operation.

Embodiments of the present disclosure may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Example embodiments of the present disclosure may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that, within the scope of the appended claims, the disclosure of this application may be practiced otherwise than as specifically described herein.

Further, elements and/or features of different example embodiments and/or examples may be combined with each other and/or substituted for each other within the scope of this disclosure and appended claims.

Still further, any one of the above-described and other example features of the present disclosure may be embodied in the form of an apparatus, method, system, computer program or computer program product. For example, the aforementioned methods may be embodied in the form of a system or device, including, but not limited to, any of the structures for performing the methodology illustrated in the drawings.

Even further, any of the aforementioned methods may be embodied in the form of a program. The program may be stored on a computer readable medium and configured to perform any one of the aforementioned methods when run on a computer device (a device including a processor). Thus, the storage medium or computer readable medium can be configured to store information and interact with a data processing facility or computer device to perform the method of any of the above-described embodiments.

The storage medium may be a built-in medium installed inside a computer device main body or a removable medium arranged so that it can be separated from the computer device main body. Examples of the built-in medium include, but are not limited to, rewriteable non-volatile memories, for example, ROMs and flash memories, and hard disks. Examples of the removable medium include, but are not limited to, optical storage media (for example, CD-ROMs and DVDs), magneto-optical storage media (for example, MOs), magnetic storage media (including but not limited to floppy diskettes, cassette tapes, and removable hard disks), media with a built-in rewriteable non-volatile memory (including but not limited to memory cards), and media with a built-in ROM (including but not limited to ROM cassettes), etc. Furthermore, various information regarding stored images, for example, property information, may be stored in any other form, or provided in other ways.

Examples and embodiments being thus described, it should be apparent to one skilled in the art after reading this disclosure that the examples and embodiments may be varied in many ways. Such variations are not to be regarded as a departure from the spirit and scope of the present disclosure, and such modifications are not excluded from the scope of the following claims.

What is claimed is:

1. An image forming apparatus, comprising:
a plurality of media trays configured to load media sheets thereon;
a specifying device configured to specify a condition on a media sheet for an image to be formed thereon and one media tray of the plurality of media trays;
an acquisition device configured to acquire a condition on a media sheet to be loaded in the media tray specified using the specifying device; and
a determination device configured to determine the presence or absence of the media sheet in accordance with the specified condition in the specified media tray by comparing the specified condition and the acquired condition,
wherein, when the determination device determines the absence of the media sheet in accordance with the specified condition in the specified media tray, another media tray of the plurality of media trays is searched for the media sheet in accordance with the specified condition, and
wherein, when the media sheet in accordance with the specified condition is found in the another media tray, the media sheet is fed from the another media tray.

2. The image forming apparatus according to claim 1, wherein the specified condition is a size and type of the media sheet.

3. The image forming apparatus according to claim 2, further comprising a switching device configured to switch between on and off states of a first feeding mode in which, when the determination device determines the absence of the media sheet of the specified size and type in the specified media tray, another media tray of the plurality of media trays is searched for the media sheet of the specified size and type, and when the media sheet of the specified size and type is found in the another media tray, the media sheet is fed from the another media tray, and a second feeding mode in which, when the determination device determines the absence of the media sheet of the specified size and type in the specified media tray, the specified type is disabled and another media tray of the plurality of media trays is searched for the media sheet of the specified size, and when the media sheet of the specified size is found in the another media tray, the media sheet is fed from the another media tray.

4. The image forming apparatus according to claim 3, wherein, when both the first feeding mode and the second feeding mode are set to off state using the switching device, a third feeding mode is set for feeding a media sheet from a predetermined one media tray of the plurality of media trays.

5. The image forming apparatus according to claim 3, wherein, when both the first feeding mode and the second feeding mode are set to off state using the switching device, a feeding mode to be preferentially performed is set to a predetermined one of the first feeding mode, the second feeding mode, and a third feeding mode for feeding a media sheet from a predetermined one media tray of the plurality of media trays.

6. The image forming apparatus according to claim 1, further comprising a notification device configured to notify a message requesting an operator to load the media sheet in accordance with the specified condition in the specified media tray when the determination device determines the absence of the media sheet in accordance with the specified condition in the specified media tray.

7. The image forming apparatus according to claim 1, wherein the specifying device is configured so that an operator manually specifies the condition on the media sheet and the media tray.

8. A method of feeding a media sheet for use in an image forming apparatus including a plurality of media trays, the method comprising:
setting a condition on a media sheet to be loaded in each of the plurality of media trays;
specifying a condition on a media sheet for an image to be formed thereon and one media tray of the plurality of media trays;
acquiring the condition set by the setting;
determining whether the condition acquired by the acquiring matches the condition specified by the specifying;
determining the presence or absence of the media sheet in accordance with the specified condition in the specified media tray;
searching another media tray of the plurality of media trays for the media sheet in accordance with the specified condition when the absence of the media sheet in accordance with the specified condition in the specified media tray is determined by the determining; and
feeding the media sheet in accordance with the specified condition from the another media tray when the media sheet is found in the another media sheet by the searching.

9. The method according to claim 8, wherein the specified condition is a size and type of the media sheet.

10. The method according to claim 9, further comprising:
switching between on and off states of a first feeding mode in which,
when the absence of the media sheet of the specified size and type in the specified media tray is determined, another media tray of the plurality of media trays is searched for the media sheet of the specified size and type, and
when the media sheet of the specified size and type is found in the another media tray, the media sheet is fed from the another media tray,
and a second feeding mode in which,
when the absence of the media sheet of the specified size and type in the specified media tray is determined, the specified type is disabled and another media tray of the plurality of media trays is searched for the media sheet of the specified size, and when the media sheet of the specified size is found in the another media tray, the media sheet is fed from the another media tray.

11. The method according to claim 10, wherein, when both the first feeding mode and the second feeding mode are set to off state, a third feeding mode is set for feeding a media sheet from a predetermined one media tray of the plurality of media trays.

12. The method according to claim 10, wherein, when both the first feeding mode and the second feeding mode are set to off state, a feeding mode to be preferentially performed is set to a predetermined one of the first feeding mode, the second feeding mode, and a third feeding mode for feeding a media sheet from a predetermined one media tray of the plurality of media trays.

13. The method according to claim 8, further comprising:
generating a message requesting an operator to load the media sheet in accordance with the specified condition in the specified media tray when the absence of the media sheet in accordance with the specified condition in the specified media tray is determined.

14. The image forming apparatus according to claim 8, wherein an operator manually specifies the condition on the media sheet and the media tray.
